(19) United States
(12) Patent Application Publication
(10) Pub. No.: US 2024/0407590 A1
(43) Pub. Date: Dec. 12, 2024

(54) CONTAINER, DEVICE AND METHOD FOR PRODUCING A LIQUID CLEANING AGENT

(71) Applicant: SCHAERER AG, Zuchwil (CH)

(72) Inventors: André SCHWERY, Thun (CH); Laurent HÄFLIGER, Lohn-Ammansegg (CH); Michael VON DÄNIKEN, Rothrist (CH); Florian FREY, Wangen bei Olten (CH)

(21) Appl. No.: 18/701,028

(22) PCT Filed: Oct. 13, 2022
(86) PCT No.: PCT/IB2022/059829

§ 371 Date: Apr. 12, 2024

(30) Foreign Application Priority Data
Oct. 15, 2021 (CH) CH070409/2021

(51) Int. Cl. A47J 31/60; A47J 31/46

(52) U.S. Cl. CPC A47J 31/60; A47J 31/469

(57) ABSTRACT

A container for providing a liquid cleaning agent, in particular an aqueous cleaning solution for coffee machines. The container includes a container wall which defines an inner space of the container. One or more conduits open towards the inner space of the container. At least one connecting element is provided for connecting the one or more conduits to at least one external fluid conduit in a fluid-tight manner.

### FIELD OF TECHNOLOGY

The invention relates to containers and devices for producing a cleaning solution, beverage machines with such a device or container, and methods for producing a cleaning solution, according to the preamble of the independent claims.

### TECHNOLOGICAL BACKGROUND

Beverage machines such as fully automatic coffee machines must be cleaned regularly to ensure the quality of the drinks produced and to prevent breakdowns, particularly to remove limescale and grease residues. Such cleaning procedures are often time-consuming, meaning that only trained personnel or even service technicians can carry them out. As the cleaning procedures can take a long time, this results in downtimes during which the beverage machine to be cleaned cannot be used.

In order to minimize such time-consuming cleaning procedures, it is advantageous to implement automatic cleaning steps in a beverage machine. These can be carried out automatically by the machine at regular intervals, particularly at off-peak times or when the machine is switched on and off. Diverse types of automatic cleaning devices and processes for beverage machines are known from the prior art.

For example, containers with liquid cleaning agent can be provided, which can be interchangeably connected to the conduit system of a coffee machine. For example, US 2017/0295991 A1 shows a system in which cartridges with liquid descaling agent can be fluidically connected to a coupling adapter of an automatic coffee machine. The coffee machine can then draw liquid descaling agent from this cleaning cartridge as required.

Liquid cleaning agents in cartridges have the advantage that the required cleaning agent is ready to use, has defined properties and can be safely used. However, the logistics of such cleaning cartridges, in particular filling, transportation and disposal, are complex, and the liquid cleaning agent is quickly used up due to the limited capacity of the cartridges. Such solutions are therefore often too cost-intensive for machines with a high throughput and therefore also high cleaning needs, for example in the catering sector.

For larger systems, for example with multiple beverage machines operating in parallel, the liquid cleaning agent can alternatively be obtained from an external, central storage container with a larger volume, for example a canister, and supplied to the individual machines via conduits. This allows a large number of machines to be supplied cost-effectively and the supply container to be replaced quickly, regardless of the operating status of the individual beverage machines.

The cleaning agents used are intended for professional use and are therefore highly concentrated. With regard to workplace safety, this requires adequate protective measures and suitable training for operating personnel. Due to the greater hazard potential and the regulations to be observed for safe transportation, large containers with potentially hazardous liquid chemicals are also more complex in terms of logistics. Correct disposal of empty containers must also be ensured, as they may contain residues of corrosive substances.

The use of solid cleaning agents is also possible. For example, cleaning agents in tablet form can be inserted into the feed chute for pre-ground coffee powder in automatic coffee machines in order to provide the cleaning agent for a cleaning cycle. However, this requires a manual step by an operator, which makes automatic operation impossible. In addition, users may try to avoid inserting a cleaning tablet for cost reasons or use unsuitable products from third-party manufacturers, which makes it impossible to clean the machine properly and can cause consequential damage.

EP 3192411 A1 shows a system for automatic beverage machine cleaning. Solid or gel-like cleaning agent is located in a container and is sprayed with water from below. The cleaning agent is dissolved and the resulting cleaning solution drips back into a collecting vessel. The design of such a cleaning device is complex and the operation parameters are difficult to control.

A descaling agent application device is known from CH 709738 A1, which comprises a reusable container for descaling agent. The container is connected to a beverage machine to carry out a descaling process. In one embodiment, the container comprises a bag in which a powdered descaling agent is stored instead of a ready-made descaling solution. The container contains powdered descaling solution to produce a volume of descaling solution that corresponds to the volume of the container. Water is added from above to dissolve the descaling agent. The finished descaling solution is then pumped out of the container through an outlet conduit located at the bottom. In an alternative embodiment, the outlet conduit at the bottom is used to pump water into the container. After the descaling agent has dissolved and the ready-made descaling solution is available, valves are switched on the pump side and the descaling solution is pumped into the conduit system of the coffee machine.

There is a general need for improvements in this area.

### REPRESENTATION OF THE INVENTION

It is an object of the invention to provide containers and devices for the production of a liquid cleaning agent, in particular an aqueous cleaning solution, which avoid the above-mentioned and other disadvantages of known devices.

It is further an object of the invention to provide a beverage machine with such a device, or for the use of such containers, respectively.

In particular, a container according to the invention should be safe to transport and handle. It should also have a high capacity so that the container rarely needs to be replaced. A device according to the invention should be able to maintain an autonomous cleaning operation without manual intervention for as long as possible.

These and other objects are solved by the elements of the independent claims. Further advantageous embodiments can be found in the dependent claims and the description.

The solution according to the invention can be further improved by various embodiments, each of which is advantageous in themselves and, unless otherwise stated, can be combined with one another as desired. These embodiments and the advantages associated with them are discussed below.

A first aspect of the invention relates to a container for providing a liquid cleaning agent, in particular an aqueous cleaning solution for coffee machines. Such a container according to the invention comprises a container wall which defines an inner space of the container; one or more conduits which open towards the inner space of the container; and at least one connecting element for the fluid-tight connection of the one or more conduits to at least one external fluid conduit.

In an advantageous embodiment of a container according to the invention, a certain amount of a water-soluble substance for producing a liquid cleaning agent is present in the inner space of the container.

Such a water-soluble substance can comprise a water-soluble solid, a water-soluble liquid, a water-soluble gel, a water-soluble paste, or mixtures thereof.

Such a solution makes it possible to provide a larger quantity of liquid cleaning agent, by dissolving the water-soluble substance in portions, than if the liquid cleaning agent is provided directly in a container of the same size.

Another advantage, particularly in the case of highly viscous or solid substances, is that the chemical compounds in question in solid or highly viscous form are substantially safer in the handling, the transport, and in terms of the general potential for harm to people and the environment than liquid compounds, which can leak or splash around, for example. Accordingly, the regulatory requirements with regard to transportation and workplace safety are less stringent.

The water-soluble substance is advantageously a water-soluble solid, particularly advantageously in the form of a granulate or a free-flowing powder.

The water-soluble substance can contain more than one chemical compound.

When the water-soluble substance is dissolved in water, an aqueous cleaning solution is produced. If necessary, this aqueous solution can be further diluted. For example, the concentration of the cleaning solution can be adapted to the parameters of a beverage machine to be cleaned, such as operating hours, maintenance status, hardness of the tap water supplied, or the type and number of beverages produced. It is also possible to determine the actual concentration of the aqueous solution, for example by measuring the pH or electrical conductivity. This can then be used to determine the dilution still required to achieve a target concentration.

To ensure that the cleaning solution is safe for use in a beverage machine and can be disposed of in diluted form in the normal wastewater drain after use, it should be harmless to humans and the environment in diluted concentration.

To produce a liquid descaling agent, the water-soluble substance advantageously contains an acid that is solid at room temperature, for example tartaric acid, citric acid, amidosulfonic acid, oxalic acid, glycolic acid, malic acid, lactic acid, or mixtures thereof. When the water-soluble substance is dissolved in water, an acidic aqueous solution is formed. When this is pumped through the conduit system of a beverage machine, limescale deposits will dissolve.

To produce a liquid alkaline cleaning agent, the water-soluble substance can contain a base, for example sodium hydrogen carbonate, sodium carbonate, sodium hydroxide, or mixtures thereof. When the water-soluble substance is dissolved in water, an alkaline aqueous solution is produced. When this is conveyed through the conduit system of a beverage machine, fat deposits will dissolve.

The water-soluble substance may additionally contain suitable anionic and/or non-ionic surfactant compounds in order to improve the cleaning effect. Advantageously, an anionic surfactant is used, particularly advantageously an anionic surfactant with a sulfonic acid group, for example sodium dodecylbenzene sulfonate.

In a further advantageous variant, a certain amount of a water-insoluble material such as sand, ceramic granules or plastic granules can be arranged in the inner space of the container. This inert material can impede clumping and can prevent blockage of flow paths within the container when a flexible container collapses.

In a further advantageous variant of such a container according to the invention, a conduit of the one or more conduits opens at one end of the container towards the inner space of the container.

Furthermore, a conduit of the one or more conduits can in a central zone of the container open towards the inner space of the container.

Advantageously, one conduit of the one or more conduits is arranged inside the container. A conduit arranged in the inner space of the container can be rigid or flexible.

A conduit of the one or more conduits of a container according to the invention is advantageously detachably connected or connectable to the container.

Such an embodiment has the advantage that a container according to the invention can have a modular structure. For example, a container can be reusable in that new water-soluble substance can be refilled after detaching the conduits. It is also possible to reuse the detachably connectable conduit.

In another advantageous embodiment of a container according to the invention, a first conduit of the one or more conduits opens at a first end of the container towards the inner space of the container. A second conduit of the one or more conduits opens at a second end of the container, facing away from the first end, towards the inner space of the container.

Amongst other things, such a solution has the advantage that water can be added at one end of the container and cleaning solution can be retrieved at the other end.

A container according to the invention can have a first connecting element for the fluid-tight connection of the first conduit of the container to an external fluid conduit, and a second connecting element for the fluid-tight connection of the second conduit of the container to an external fluid conduit.

Advantageously, in such a container according to the invention, the first connecting element and the second connecting element are arranged at a first end of the container, and the first conduit extends from the first connecting element in the inner space of the container to an opposite second end of the container.

One of the advantages of such a solution is that all connections can be provided at one end of the container and yet the access points within the container are located at two different ends of the container.

It is particularly advantageous for the first connecting element and the second connecting element to be designed as a common connecting element.

The container wall of a container according to the invention can be made entirely or partially from plastic or from a multi-layer composite material.

In a container according to the invention, the volume of the inner space of the container can be invariable.

When in such a variant water is added or cleaning solution is retrieved, the pressure inside the container changes if it is sealed off from the atmosphere. To avoid or reduce this effect, a permanent or temporary connection of the inner space of the container to the atmosphere or a pressure equalization container can be provided.

Alternatively, in a container according to the invention, the volume of the inner space of the container can be reversibly variable between a first volume and a second volume.

If water is added or cleaning solution is retrieved in such a variant, the pressure inside the container can be passively or actively kept constant.

Advantageously, the container wall of such a container according to the invention consists entirely or partially of a flexible material, for example a flexible film.

Alternatively or additionally, the container according to the invention can be designed as a tubular bag or foil bag.

Such a container according to the invention can advantageously also have a first, flexible wall and a second, rigid wall, the first wall and the second wall being sealingly connected to one another and thereby defining the inner space of the container.

Another advantageous variant of a container according to the invention has a first, rigid wall and a second, rigid wall, the first wall and the second wall being sealingly connected to one another via a flexible intermediate element and thereby defining the inner space of the container.

In an advantageous embodiment of such a container according to the invention, the container wall comprises a tubular cartridge and a piston, which is arranged in the said tubular cartridge so as to be displaceable along the longitudinal axis of the cartridge, and which closes the cartridge in a sealing manner at one end.

In another advantageous embodiment of such a container according to the invention, the container wall comprises a bellows.

Advantageously, in a container according to the invention, a structure is provided in the inner space of the container, which at a minimum volume of the container ensures a fluidic connection between the connecting element and the entire inner space of the container.

Particularly advantageously, in such a container according to the invention the fluidic connection structure comprises channels and/or ribs arranged on the inside of the container wall. Alternatively or additionally, the fluidic connecting structure comprises an insert element arranged in the inner space of the container, for example an inserted grid.

One of the advantages of such an embodiment is that when a flexible container collapses due to the external pressure during the retrieval of liquid, the walls of the flexible container abutting on each other cannot constrict any part of the container.

Advantageously, the inner space of a container according to the invention is partially or completely vented.

In a further advantageous embodiment of a container according to the invention, one or more connecting elements comprise a puncture membrane or a septum.

Such a variant of a container according to the invention has the advantage that the contents of a container according to the invention, which can be harmful to health due to its corrosive effect, cannot escape unintentionally.

One or more connecting elements of a container according to the invention can comprise a quick coupling.

One or more connecting elements of a container according to the invention can also comprise at least one non-return valve.

Such a variant of a container according to the invention has the advantage that, for example, water and cleaning solution can be fed through the same conduit sections without having to provide complex controlled valve devices.

In another advantageous embodiment of a container according to the invention, one or more connecting elements comprise a pressure relief valve which, when triggered, connects the inner space of the container to the atmosphere or an external overflow conduit.

This variant of a container according to the invention has the advantage that in the event of unforeseen overpressure in the container, the overpressure can be released in a controlled manner, in order to prevent the container from bursting in an uncontrolled manner. The external overflow conduit can, for example, be connected to a drip tray or the wastewater drain in order to safely collect or drain off any cleaning fluid that may escape.

In yet another advantageous embodiment of a container according to the invention, one or more connecting elements comprise a vent valve, with which the inner space of the container can be connected to the atmosphere or an external vent conduit.

A second aspect of the invention relates to an apparatus for producing a liquid cleaning agent. Such an apparatus according to the invention comprises at least one container according to the invention; a first external conduit for supplying water into the container; a second external conduit for retrieving liquid cleaning agent from the container; a first external connecting element, which can be coupled in a fluid-tight manner to a connecting element of the container in such a way that the first external conduit is fluidically connected to a first conduit of the container; and a second external connecting element, which can be coupled in a fluid-tight manner to a connecting element of the container in such a way that the second external conduit is fluidically connected to the first conduit or to another, second conduit of the container.

Advantageously, in such a device according to the invention, the first external conduit and the second external conduit are identical.

Amongst other things, such a variant of a device according to the invention has the advantage that only one external conduit needs to be provided between the at least one container and, for example, a feed pump of the device. The pump can both convey water through this conduit into the container and also convey cleaning solution from the container and further into the conduit system of a beverage machine.

In an advantageous variant of a device according to the invention, a connecting element of the device can be mechanically operatively connected to a connecting element of the at least one container by means of a screw connection or a bayonet connection.

In another advantageous variant of a device according to the invention, a connecting element of the device has a hollow needle fluidically connected to the associated external conduit, with which a puncture membrane or a septum of a connecting element of the at least one container can be punctured, in order to create a fluidic connection between the external conduit and the conduit of the container associated with the connecting element of the container.

A further advantageous embodiment of a device according to the invention comprises a sensor for measuring the flow rate of liquid in a conduit from and/or to the container; and/or a sensor for measuring the electrical conductivity of a liquid in the conduit and/or in the container; and/or a sensor for measuring the pH of a liquid in the conduit and/or in the container.

Advantageously, a device according to the invention has a pump device which is set up to convey liquid through a conduit into the at least one container, and/or to convey liquid through a conduit out of the container.

Still another advantageous embodiment of a device according to the invention comprises a weighing device, which is adapted to determine the weight of the at least one container including its contents.

A device according to the invention can be equipped as a separate unit that can supply one or more beverage machines with cleaning solution, or it can be designed as an integral part of a beverage machine.

A third aspect of the invention relates to a beverage machine with a device according to the invention for producing a cleaning solution.

A fourth aspect of the invention relates to a beverage machine with a container according to the invention for providing a cleaning solution.

The term beverage machine within the meaning of the invention includes machines and devices which can produce beverages automatically or semi-automatically and/or dispense beverages in portions to a user, in particular coffee machines, hot beverage makers, cold beverage makers, etc.

A fifth aspect of the invention relates to a method for preparing a liquid cleaning agent, in particular a cleaning solution for coffee machines. Such a method according to the invention comprises the steps of:
providing at least one container according to the invention, wherein a certain amount of a water-soluble substance for producing a liquid cleaning agent is present in the inner space of the container;
supplying a certain amount of water into the inner space of the container through a conduit of the container;
dissolving at least a portion of the water-soluble substance in the container in the added amount of water to form a liquid cleaning agent in the form of an aqueous solution; and
retrieving of a certain amount of the liquid cleaning agent from the container through a conduit of the container.

In an advantageous variant of a method according to the invention, after retrieving a predetermined amount of the liquid cleaning agent from the at least one container, a further certain amount of water is added to the container.

Advantageously, in the method according to the invention, so much of the water-soluble substance is dissolved in the amount of water added that a saturated solution is formed. A saturated solution has the advantage that the concentration of the cleaning solution is maximized.

To provide a ready-to-use aqueous cleaning solution, the aqueous solution taken from the at least one container can be diluted with water before use in order to obtain the desired concentration of the cleaning solution.

One of the advantages of this is that the concentration of the cleaning solution can be adapted to the parameters of the beverage machine to be cleaned, for example operating hours, maintenance status, hardness of the tap water supplied or the type and number of beverages produced. It is also possible to determine the required dilution of the aqueous solution to achieve the desired concentration of the cleaning solution.

The actual concentration of the aqueous solution can be estimated on the basis of empirical values and operating parameters, or it can be determined quantitatively, for example by measuring the pH value and/or the electrical conductivity of the aqueous solution.

Advantageously, in the method according to the invention, the concentration of the aqueous solution retrieved from at least one container is measured. This can be done, for example, by measuring the conductivity or the pH value.

In the method according to the invention, the same conduit of the container can be used for feeding the water into the at least one container and for retrieving the liquid cleaning agent from the container.

Advantageously, in the method according to the invention, a negative pressure is applied to the retrieving conduit of the at least one container for the retrieving of the liquid cleaning agent.

In a further advantageous embodiment of a process according to the invention, the amount of water introduced into the container, the dwell time of the water in the container, the amount of aqueous solution retrieved and, if necessary, a subsequent dilution of the aqueous solution retrieved are selected as a function of the expected dissolution rate of the water-soluble substance in such a way that a certain amount of cleaning solution can be provided at any given time.

Further aspects of the present invention are also apparent from the following description.

### BRIEF DESCRIPTION OF THE DRAWINGS

For a better understanding of the present invention, reference is made to the appended drawings. These merely show embodiments of the subject matter of the invention and are not intended to limit the invention to the features disclosed herein.

FIG. 1 schematically shows an embodiment of a container according to the invention, with a connecting element and two conduits connected to external conduits of a device, (a) in an initial state before the first filling, (b) after a first filling with water, (c) after a first retrieval of cleaning solution, and (d) after several filling and retrieving cycles.

FIG. 2 schematically shows another embodiment of a container according to the invention, with two connecting elements and two conduits connected to external conduits of a device (a) in an initial state before the first filling, (b) after a first filling with water, and (c) after a first retrieval of cleaning solution.

FIG. 3 schematically shows a further embodiment of a container according to the invention, with a connecting element and two conduits, in an initial state before the first filling.

FIG. 4 schematically shows yet a further embodiment of a container according to the invention, with a connecting element and a conduit, in an initial state before the first filling.

FIG. 5 schematically shows yet another embodiment of a container according to the invention, with a connecting element and a conduit, in an initial state before the first filling.

FIG. 6 schematically shows another embodiment of a container according to the invention, with a connecting element and two conduits, with a schematic conduit diagram within the connecting elements.

FIG. 7 schematically shows yet a further embodiment of a container according to the invention, with a connecting element and two conduits, with a schematic conduit diagram within the connecting elements.

FIG. 8 schematically shows another embodiment of a container according to the invention, with a connecting element and two conduits, with a schematic conduit diagram within the connecting elements.

FIG. 9 schematically shows another embodiment of a container according to the invention, with a flexible conduit inside the container.

FIG. 10 schematically shows a further embodiment of a container according to the invention with a bellows-shaped container wall, (a) with a first volume, and (b) with a second, smaller volume.

FIG. 11 shows a perspective view of another embodiment of a container according to the invention in the form of a stand-up pouch with a rigid conduit arranged in the inner space.

FIG. 12 shows an illustration of a further embodiment of a container according to the invention in the form of a stand-up pouch with a conduit in the form of a metal tube arranged in the inner space.

### WAYS TO CARRY OUT THE INVENTION

In the following description, identical or similar parts are marked with the same or similar reference symbols. Top and bottom in the space correspond to top and bottom in the figures.

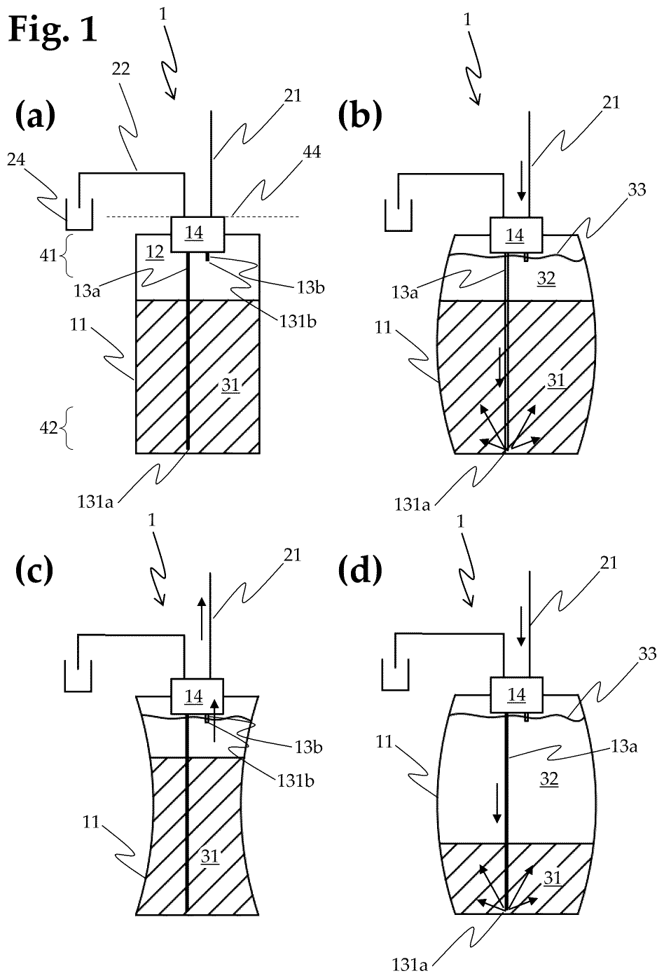

A possible embodiment of a container 1 according to the invention for providing cleaning agent is shown schematically in FIG. 1. The container 1 comprises a container wall 11, which defines the inner space 12 of the container. In the embodiment example shown, the container wall has a flexible design. For example, it can be made of film, in particular in the form of a tubular bag.

FIG. 1(a) shows the container 1 according to the invention in a basic state, as it reaches the user after manufacture. The bag is filled with water-soluble substance in the form of granulated solid 31, from which a liquid cleaning solution 32 can be produced by adding water. In its basic state, the illustrated container 1 according to the invention contains no water.

Advantageously, the container is vented or vacuum-packed. In this way, the volume is minimal, which optimizes the costs for transport and storage.

The container 1 is operatively connected to external conduits 21, 22 of a device (not shown) for the production of cleaning agents.

A connecting element 14 is arranged at an upper end 41 of the container 1. A conduit 13a runs from the connecting element 14 inside the container down to a lower end of the container 1, where it opens at an open end 131a of the conduit towards the inner space 12 of the container 1.

In the example shown, the conduit 13a is rigid. The conduit can be designed as a plastic tube or metal tube, for example. Such a rigid conduit is also called a lance. One of the advantages of a rigid conduit is that the spatial arrangement of the opening 131a of the conduit 13a is clearly defined in relation to the container. The conduit 13a is partially arranged within the solid 31. In particular, the end 131a of the conduit is located within the solid material.

A further, short conduit 13b runs from the connecting element 14 to an opening 131b, where it opens towards the inner space 12 at the upper end 41 of the container 1.

In an alternative embodiment, the conduit 13b can also be shortened to such an extent that it runs completely within the connecting element and the opening 131b opens directly at the connecting element 14 towards the inner space 12.

An external conduit 21 is operatively connected to the connecting element 14 and connects the conduits 13a, 13b of the container 1 to the conduit system of a device (not shown) for producing cleaning agents, in particular a pump for pumping water and cleaning solution. Via this conduit 21, both water for producing the cleaning solution is conveyed into the container, and finished cleaning solution is pumped out of the container. The connecting element 14 forms the system boundary 44 between the container 1 according to the invention and the various external elements 21, 22.

The conduit routing within the connecting element 14 is not shown. Possible variants for this are discussed in the following examples.

In the example shown, an external overflow conduit 22 is also shown, which is connected to the connecting element 14 of the container 1 and empties into a drip tray 24 or alternatively a collecting container or a wastewater drain. The overflow conduit 22 is connected to the inner space 12 via a pressure relief valve (not shown) provided in the connecting element 14. This serves to connect the inner space 12 to the exterior via one of the two conduits 13a, 13b or via a separate conduit (not shown) of the container when the pressure inside the container 1 exceeds a certain threshold value. This prevents overpressure inside the container, which could damage the container. Any escaping liquid is safely collected or drained off.

Advantageously, the overflow conduit 22 is connected to the second conduit 13b by means of the pressure relief valve.

Another advantageous use of the pressure relief valve and the overflow conduit 22 connected to it is to vent the container 1. When water is introduced into the container, the pressure inside the container increases. In the case of a rigid container, this happens immediately, and in the case of the flexible container 1 shown, when the maximum volume is reached. If the internal pressure exceeds the threshold value, any gases present in the container, for example air or inert gas, escape to the outside through the pressure relief valve. The container can be filled with water until the container is partially or completely vented. One of the advantages of venting the container in the intended operation is that no compressible gas phase is present and that undesired suction of inert gas or air by the pump can be avoided.

The pressure relief valve and the overflow conduit connected to it are optional and can also be omitted.

After a container 1 according to the invention has been prepared for use and connected to the external elements 21, 22, water is pumped through the external conduit 21 and a first conduit 13a into the inner space 12 of the container 1 in a first filling step as shown in FIG. 1(b). The arrows show the flow direction of the water. The water exits at the opening 131a at the lower end 42 of the container. The liquid level 33 rises upwards towards the upper end 41 of the container 1. The entire solid 31 is covered with water. The liquid level 33 must at least reach the opening of the second conduit 13b, as shown in the figure. Advantageously, the container 1 is completely filled with liquid.

In the flexible container 1 shown, water can be added until the inner space 12 has reached a maximum volume as shown in FIG. 1(b). Since the container and filling are known in advance, the amount of water to be added can be predetermined.

The water-soluble substance 31 now dissolves in the water, resulting in an aqueous solution 32. After a certain time, the maximum possible concentration of the dissolved compounds is reached. The solution is saturated.

In a subsequent retrieval step, the finished cleaning solution is retrieved from the container 1 (see FIG. 1(c)). The arrows indicate the direction of flow of the cleaning solution. A negative pressure is applied to the second conduit 13b via the external conduit 21, for example using the same pump of the device that was previously used to pump water into the container, and cleaning solution is conveyed away through the conduit 13b and the external conduit 21. Since the container wall 11 is flexible and not pressure-resistant, the container 1 gradually collapses due to the external pressure until pumping is stopped.

In principle, cleaning solution 32 could be pumped out of the container 1 until the remaining granulated solids 31 prevent the flexible container 1 from collapsing any further. However, it is advantageous not to empty the container 1 completely, as otherwise solid granules that have been pushed upwards could reach the second conduit 13b and be sucked in.

This cycle of filling with water and retrieving cleaning solution can now be repeated several times, whereby after each cycle the amount of remaining solids is reduced by the amount dissolved and converted into cleaning solution. In FIG. 1(d), for example, less than half of the original amount of solids 31 remains after several cycles.

This process can be continued until there is no more water-soluble substance 31 in the container. After pumping out the remaining aqueous solution, the now empty container 1 can then be removed and disposed of safely.

The advantage of such a container according to the invention is, among other things, that a significantly larger quantity of ready-to-use cleaning solution can be provided with one container than if the cleaning solution is already provided ready-to-use in a container from the outset. The container therefore needs to be replaced much less frequently.

It is advantageous to refill the container with water immediately after retrieving the cleaning liquid, which is usually used immediately. The water-soluble substance then has sufficient time to dissolve so that a saturated solution, i.e. with maximum concentration, can be produced.

In an alternative, advantageous variant, new water is added to the container a certain amount of time before the planned retrieving in order to produce the cleaning solution.

To ensure that no residual chemicals remain in the bag, one or more rinsing cycles can be carried out before the container is disposed of. For this purpose, water is filled into the container and pumped out again, whereby the solution is no longer used for cleaning but is pumped directly into a wastewater drain.

This rinsing step can also be used to rinse conduits within the production device or a beverage machine connected to it and to remove residual cleaning solution.

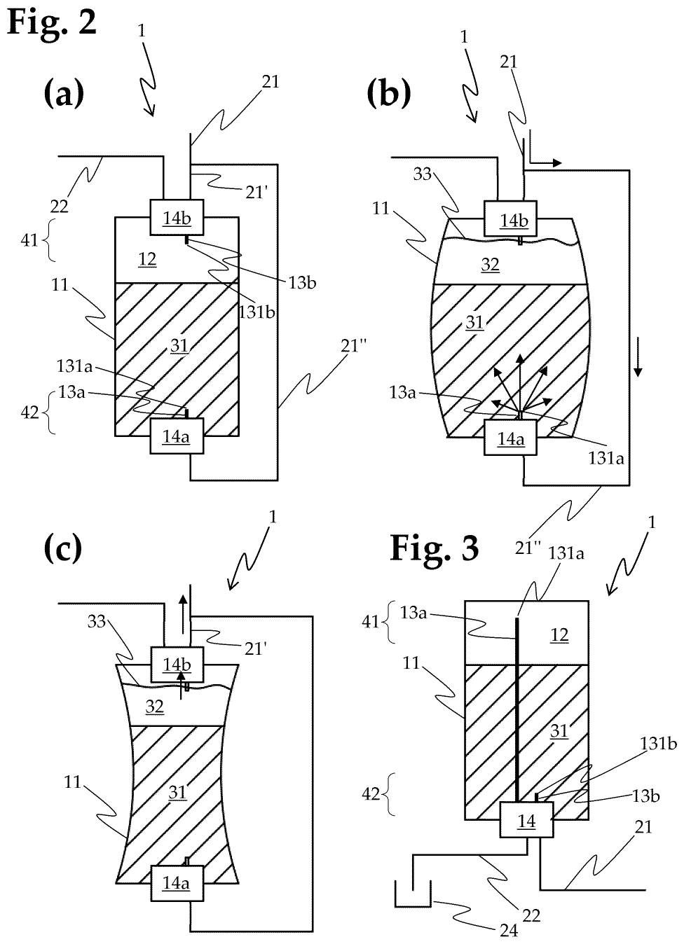

Another embodiment of a container according to the invention is shown in FIG. 2. In FIG. 2(a), the container 1 is again shown in a basic state, before the first filling. The container has two connecting elements, each with a conduit arranged in the inner space 12. The inner space is filled with a water-soluble substance in the form of granulated solid 31 to produce the cleaning solution.

A connecting element 14b is arranged at an upper end 41 of the container 1. The connecting element 14b is operatively connected to an external conduit 21′ and to an external overflow conduit 22. The overflow conduit 22, in conjunction with an overpressure valve not shown, has the same function as in the container according to the invention shown in FIG. 1. Reference is made to the discussion there.

A short conduit 13b extending from the connecting element 14b opens into the inner space 12 at an opening 131b. Again, the conduit can alternatively be arranged completely in the connecting element 14b, so that the opening 131b is located directly at the connecting element.

A further connecting element 14a is arranged at a lower end 42 of the container 1 and is connected to an external conduit 21″. A short conduit 13a extending from the connecting element 14a opens into the inner space 12 at the lower end 41 of the container 1 at an opening 131a. The conduit 13a and its opening are located in the solid material 31.

Again, the conduit 13a can alternatively be arranged completely in the connecting element 14a, so that the opening 131a is located directly at the connecting element.

The external conduit 21″ connected to the connecting element 14a and the external conduit 21′ connected to the connecting element 14b run together to form a common conduit 21, which runs to the device (not shown) for producing the cleaning solution.

The first filling step is shown in FIG. 2(b). Water is conveyed into the container 1 via the external conduit 21, 21″ (flow direction shown by arrows), and flows through the conduit 13a and opening 131a into the inner space 12, where it dissolves the water-soluble substance in the form of the granulated solid 31 and forms the cleaning solution 32. The liquid level 33 rises to the upper end 41 of the container 1. The volume of the container is maximized. This process is analogous to the filling step according to the previously discussed FIG. 1(b).

The subsequent retrieval step of the cycle is shown in FIG. 2(c). A negative pressure is applied to the conduit 13b via the external conduit 21, 21′. Cleaning fluid 32 is sucked in through the opening 131b and conveyed to the device via the conduit 21, 21′ (flow direction shown by arrows). This process is analogous to the retrieval step according to the previously discussed FIG. 1(c).

The correct flow of water or cleaning fluid in the conduits 21, 21′, 21″ can be achieved, for example, by using appropriate valves (not shown).

The illustrated embodiment of a container according to the invention has the advantage that no conduit spans the inner space of the container, which simplifies manufacture.

FIG. 3 shows another advantageous variant of a container 1 according to the invention in the basic state before the first filling with water. The depicted container 1 corresponds in structure to the container 1 of FIG. 1(a), in an upside-down arrangement rotated by 180°.

In such an embodiment, the long, rigid conduit 13a and the short conduit 13b swap their functional roles. Water is conveyed through the short conduit 13b into the lower zone 42 of the container 1, while cleaning fluid is retrieved from the upper end 41 of the container 1 through the opening 131a of the long, rigid conduit 13a.

The overflow conduit 22 is connected to the conduit 13a via a pressure relief valve (not shown).

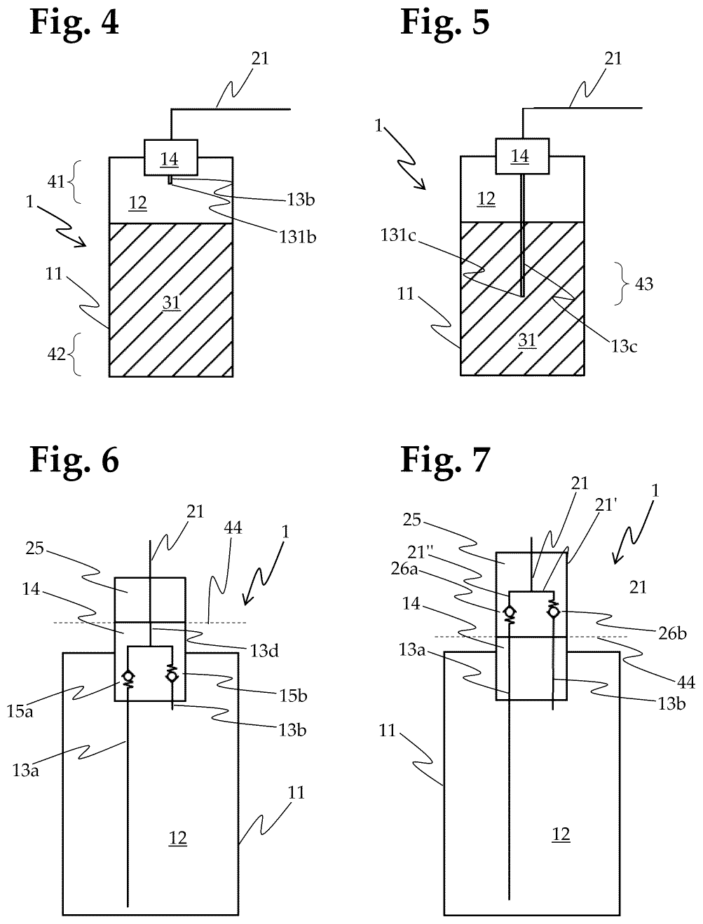

A further advantageous variant of a container 1 according to the invention is shown in FIG. 4, in the basic state before the first filling with water. The container has a connecting element 14 at its upper end 41, which is connected to an external conduit 21. A short conduit 13b runs away from the connection 14 in the inner space and opens 131b into the inner space 12 at the upper end 41 of the container 1.

To fill the container with water, water is pumped through the external conduit 21 and the conduit 13b and flows from above onto the water-soluble substance in the form of a granulated solid 31, from where the water seeps down to the lower end 42 of the container 1. To retrieve the cleaning solution, it is sucked out of the container 1 through the same conduit 13b

While this embodiment can be easily manufactured, it has the disadvantage over the previously discussed embodiments that there is no liquid flow through the bed of granulated solid 31. As a result, it takes longer until a saturated solution is present in the head zone 41, since saturated solution can only reach the top from the zone of the granulated solid 31 by comparatively slow diffusion.

Another advantageous variant of a container 1 according to the invention is shown in FIG. 5, in the basic state before the first filling with water. The container again has a connecting element 14 at its upper end 41, which is connected to an external conduit 21. A conduit 13c runs in the inner space from the connection 14 to the middle zone 43 of the container 1, where it opens into the inner space 12 at the opening 131c.

FIGS. 6 and 7 show two possible variants of a conduit diagram, with which in a connecting element 14 of a container 1 according to the invention, with two conduits 13a, 13b connected thereto and an external connecting element 25 operatively connected thereto without active control, the correct flow of water or cleaning solution is ensured during the two operational steps of filling and emptying.

In a first variant, as shown in FIG. 6, two opposing spring-loaded non-return valves 15a, 15b are arranged in the connecting element 14, each of which connects one of the two conduits 13a, 13b to a common conduit 13d. This conduit 13d is connected in a fluid-tight manner to the external conduit 21 at an interface of the two connecting elements 14, 25, which is only shown schematically. The interface is advantageously designed so that when the two connecting elements 14, 15 are decoupled, one or both conduits 13d, 21 are automatically closed, in order to prevent unwanted fluid leakage. Corresponding fluidic couplings are known to those skilled in the art.

When water is conveyed through the conduit 21, 13d into the container 1 during the intended operation, the valve 15b closes while the valve 15a opens. The water flows as intended through the conduit 13a into the inner space 12 of the container 1. When a negative pressure is generated in the conduit 21, 13d by a pump, the valve 15a closes and the valve 15b opens. Cleaning solution can now be conveyed out of the container through conduit 13b.

In a second variant, as shown in FIG. 7, the two conduits 13a, 13b in the connecting element 14 are extended to the interface to the connecting element 25, where they are connected in a fluid-tight manner to corresponding conduits 21′, 21″. These are connected to a common conduit 21 via oppositely oriented non-return valves 26a, 26b.

When water is pumped through the conduit 21 into the container 1 during the intended operation, the valve 26b closes while the valve 26a opens. The water flows as intended through the conduit 21″, 13a into the inner space 12 of the container 1. When a negative pressure is generated in the conduit 21 by a pump, the valve 26a closes and the valve 26b opens. Cleaning solution can now be conveyed out of the container through conduit 13b, 21′.

The embodiment according to FIG. 7 has the advantage that no mechanical components are installed in the connecting element 14, which significantly reduces the manufacturing costs of the connecting element 14 and thus also of the container 1 according to the invention.

The embodiment shown in FIG. 6 has the advantage that the interface between the connecting elements comprises only one conduit, which makes for a much simpler design.

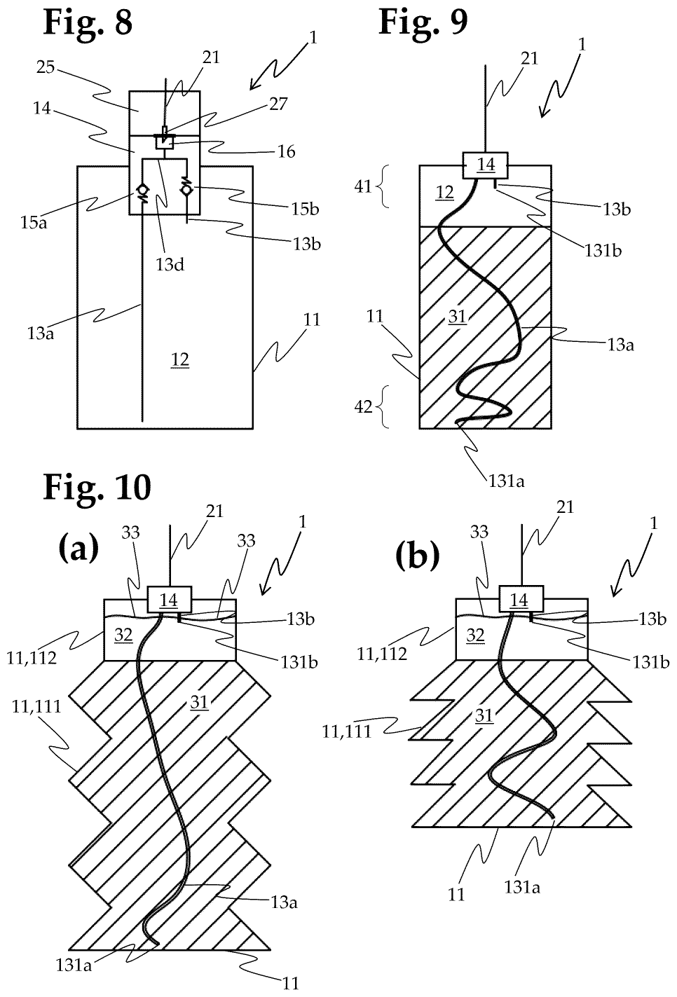

A possible embodiment of such a container 1 is schematically shown in FIG. 8. The interface between the interfaces 14 and 25 is solved via a septum 16 and a hollow needle 27. In the coupled state, the hollow needle 27, which is fluidically connected to the external conduit 21, pierces the septum 16, which sealingly closes the conduit 13 to the outside. The conduits 13d and 21 are fluidically connected.

Such an embodiment is inexpensive to manufacture, for example by means of multi-component injection molding. In the decoupled state, the container is securely closed and cannot be opened by accidental manipulation of the closure.

Such a coupling with septum and hollow needle can also be realized for two or more conduit connections to be created at the interface. For example, the coupling of the connecting elements in FIG. 7 can be realized in this way.

FIG. 9 shows a variant of the container according to the invention shown in FIG. 1, with only the differences being discussed below. An overflow conduit 22 is missing. The conduit 13a is designed as a flexible hose, which is considerably longer than the container 1, and thus is coilingly pushed together in length. The end of the hose 13a with its opening 131a is arranged at the lower end 42 of the container.

Optionally, the end of the hose at the lower end 42 can be fixed to the container wall 11, for example glued.

One of the advantages of such a solution with a flexible hose 13a over a rigid conduit is that the container 1 according to the invention can be made very flexible, since there is no rigid conduit.

Another embodiment of a container according to the invention with variable volume is shown in FIG. 10(a), after a first filling process. The container 1 is similar in design to the container in FIG. 9, with a flexible hose 13a, but the container wall 11 has a bellows 111 adjoining a rigid cylindrical section 112 on the side of the connecting element 14. When cleaning fluid 32 is retrieved, the flexible container collapses as the bellows 111 contracts.

If, after several operating cycles, the amount of water-soluble substance in the form of granulated solid 31 in the container 1 is reduced, in an advantageous operating mode the amount of water supplied can be reduced, so that the bellows zone continues to be filled with solid 31 while the cylindrical section 112 is filled with cleaning solution, as shown in FIG. 10(b). In this way, a constant quantity of cleaning solution can be hold available.

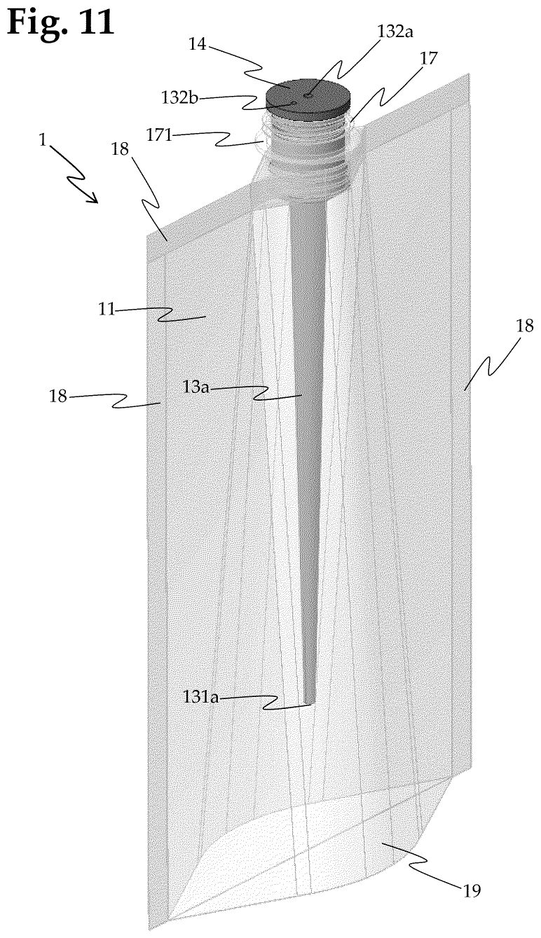

FIG. 11 shows a perspective view of a container 1 according to the invention designed as a stand-up pouch. The container is similar to stand-up pouches, such as those commonly used as refill containers for liquid soaps, shampoos and other viscous products. The container wall 11 is made from a folded piece of film, which is sealed along three edges 18, while at the lower end the film forms a stand-up base 19. A holder 17 with an opening towards the inner space of the container 1 is mounted at an upper end. Mounted in this opening is a connecting element 14 with a conduit formed thereon in the form of a conical lance 13a, the lance 13a with opening 131a being located in the inner space of the container 1. The connecting element 14 has two openings 132a, 132b on the flat outer side. One opening 132a is connected to the conduit 13a, and one opening 132b is connected to a further conduit (not visible), which opens directly at a downwardly pointing end of the connecting element 14 towards the inner space (not visible).

Functionally, such a container corresponds to the schematic representation in FIG. 7.

The holder 17 has a screw thread 171. This can be used to connect an external connecting element 25 to the connecting element 14 in a reversible form-fit. In the basic state of the container, a screw cap can also be provided, which sealingly closes the container before the first use.

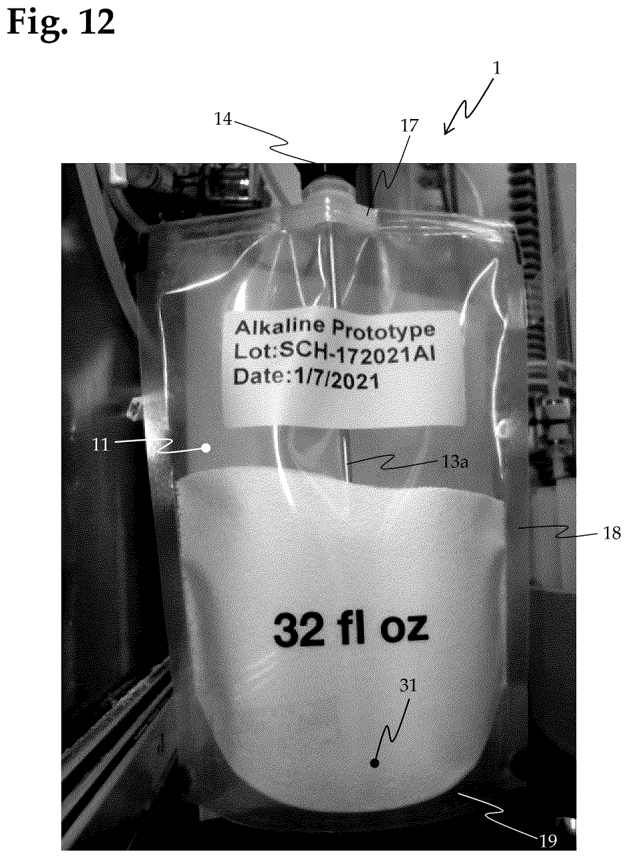

The container 1 according to the invention shown in FIG. 12 in its basic state in the form of a stand-up pouch is similar in design to that shown in FIG. 11. The connecting element 14 with a conduit 13a in the form of a rigid metal tube can be reversibly connected to the container by screwing it onto a thread of the holder 17.

Such a solution has the advantage that the connecting element 14 and the conduit 13a can be reused.

The present invention is not limited in its scope to the specific embodiments described herein. Rather, in addition to the examples disclosed herein, various further modifications of the present invention, which also fall within the scope of protection of the claims, will be apparent to those skilled in the art from the description and the accompanying figures. In addition, various references are cited in the description, the disclosure of which is hereby incorporated by reference into the description in its entirety.

### LIST OF REFERENCE SYMBOLS

1 container
11 container wall
111 bellows
112 cylindrical section
12 inner space
13a, 13b, 13c, 13d conduit
131a, 131b opening
132a, 132b opening
14, 14a, 14b connecting element
15a, 15b spring-loaded non-return valve
16 septum
17 holder
171 screw thread
18 weld seam
19 stand-up base
21, 21′, 21″ external conduit
22 overflow conduit
23a, 23b non-return valve
24 drip tray
25 external connecting element
26a, 26b spring-loaded non-return valve
27 hollow needle
31 water-soluble substance, granulated water-soluble solid
32 liquid
33 liquid level
41 top end of the container
42 bottom end of the container
43 central zone of the container
44 system boundary

1. A container for providing a liquid cleaning agent, in particular an aqueous cleaning solution for coffee machines, comprising
a container wall, which defines an inner space of the container;
one or more conduits which open towards the inner space of the container; and
at least one connecting element for the fluid-tight connection of the one or more conduits to at least one external fluid conduit.

2. The container according to claim 1, wherein a certain amount of a water-soluble substance for producing a liquid cleaning agent is present in the inner space of the container.

3. The container according to claim 1, wherein a conduit of the one or more conduits opens at one end of the container towards the inner space of the container and/or a conduit of the one or more conduits opens in a central zone of the container towards the inner space of the container.

4. (canceled)

5. The container according to claim 1, wherein a conduit of the one or more conduits is arranged in the inner space of the container.

6. (canceled)

7. (canceled)

8. The container according to claim 1, wherein a conduit of the one or more conduits is detachably connected or connectable to the container.

9. The container according to any claim 1, wherein a first conduit of the one or more conduits opens at a first end of the container towards the inner space of the container, and a second conduit of the one or more conduits opens at a second end of the container, facing away from the first end, towards the inner space of the container.

10. The container according to claim 1, comprising a first connecting element for the fluid-tight connection of the first conduit of the container to an external fluid conduit; and a second connecting element for the fluid-tight connection of the second conduit of the container to an external fluid conduit.

11. The container according to claim 10, wherein the first connecting element and the second connecting element are arranged at a first end of the container, and the first conduit extends from the first connecting element in the inner space of the container to an opposite second end of the container.

12. (canceled)

13. The container according to claim 1, wherein the volume of the inner space of the container is invariable.

14. The container according to claim 1, wherein the volume of the inner space of the container is reversibly variable between a first volume and a second volume.

15. (canceled)

16. (canceled)

17. The container according to claim 14, comprising a first, flexible wall and a second, rigid wall, the first wall and the second wall being sealingly connected to each other and thereby defining the inner space of the container.

18. The container according to claim 14, comprising a first, rigid wall and a second, rigid wall, the first wall and the second wall being sealingly connected to each other and thereby defining the inner space of the container.

19. The container according to claim 14, wherein the container wall comprises a tubular cartridge and a piston, which is arranged in said tubular cartridge so as to be displaceable along the longitudinal axis of the cartridge, and which closes the cartridge in a sealing manner at one end.

20. The container according to claim 14, wherein the container wall comprises a bellows.

21. The container according to claim 14, wherein a structure is provided in the inner space of the container, which at a minimum volume of the container ensures a fluidic connection between the connecting element and the entire inner space of the container.

22. (canceled)

23. (canceled)

24. (canceled)

25. (canceled)

26. The container according to claim 1, wherein one or more connecting elements comprise at least one non-return valve, and/or a pressure relief valve which, when triggered, connects the inner space of the container to the atmosphere or an external overflow conduit, and/or a vent valve, with which the inner space of the container can be connected to the atmosphere or an external vent conduit.

27. (canceled)

28. (canceled)

29. A device for producing a liquid cleaning agent, comprising at least one container according to claim 1;
a first external conduit for supplying water to the container;
a second external conduit for retrieving liquid cleaning agent from the container;
a first external connecting element, which can be coupled in a fluid-tight manner to a connecting element of the container in such a way that the first external conduit is fluidically connected to a first conduit of the container; and
a second external connecting element, which can be coupled in a fluid-tight manner to a connecting element of the container in such a way that the second external conduit is fluidically connected to the first conduit or another, second conduit of the container.

30. (canceled)

31. A beverage machine with a device for producing a cleaning solution according to claim 29.

32. A beverage machine comprising a container for providing a cleaning solution according to claim 1.

33. A method of preparing a liquid cleaning agent, in particular a cleaning solution for coffee machines, comprising the steps of:
providing at least one container according to claim 1, wherein a certain amount of a water-soluble substance for producing a liquid cleaning agent is present in the inner space of the container;
feeding a certain amount of water into the inner space of the container through a conduit of the container;
dissolving at least a portion of the water-soluble substance in the container in the added amount of water to form a liquid cleaning agent in the form of an aqueous solution; and
retrieving a certain amount of the liquid cleaning agent from the container through a conduit of the container.

34. The method according to claim 33, wherein after retrieving a predetermined amount of the liquid cleaning agent from the at least one container, a further predetermined amount of water is added to the container.

35. (canceled)

36. (canceled)
